(19) United States
(12) Patent Application Publication
(10) Pub. No.: US 2002/0077973 A1
(43) Pub. Date: Jun. 20, 2002

(54) Method and apparatus for issuing prepaid e-cash and calling cards and method of using the same

(76) Inventors: Corrado Ronchi, Rome (IT); Izzat Bakhadyrov, Highland Park, NJ (US)

Correspondence Address: AMSTER, ROTHSTEIN & EBENSTEIN, 90 PARK AVENUE, NEW YORK, NY, 10016

(21) Appl. No.: 09/739,547

(22) Filed: Dec. 15, 2000

(51) Int. Cl. G06F 17/60

(52) U.S. Cl. 705/39

(57) ABSTRACT

The present invention relates to a method and apparatus for distributing, issuing, validating and implementing pre-paid cards to be used in e-commerce and telephone calling applications. In particular, the present invention includes a Prepaid Validation Device (hereinafter, “PVD”) for issuing prepaid cards, the PVD having a removable Memory Unit on which Personal Identification Numbers (“PINS”) are stored. The PINS are divided into PIN groups and uploaded to Memory Units by a Reseller of PINS. A database of PINS is stored in the Memory Unit, where the database is divided into several layers of PINS. Initially, the first layer of PINS is activated and the remaining layers are inactive and inaccessible. However, the remaining layers may be activated by placing an activation order and then accessed by an PIN unlocking procedure. The method of the present invention provides for instant, on-site issuance of pre-paid cards which are used in conjunction with a system over which a card holder may either place a telephone call or purchase goods and services from a variety of retailers at a single location, i.e., an Internet web site, through a single transaction.

### FIELD OF THE INVENTION

The present invention relates to a method and apparatus for issuing, validating and implementing pre-paid cards to be used in e-commerce and long distance calling applications. In particular, the present invention includes a Prepaid Validation Device (hereinafter, “PVD”) for issuing prepaid cards, the PVD having a removable Memory Unit on which Personal Identification Numbers (hereinafter, “PINs”) are stored. The method of the present invention provides for instant, on-site issuance of pre-paid cards which are used in conjunction with a system over which a card holder may either place a telephone call or purchase goods and services from a variety of retailers at a single location, i.e., an Internet web site, through a single transaction.

### BACKGROUND OF THE INVENTION

There are a variety of known methods and apparatus for issuing and validating prepaid debit cards, including those commonly used in the prepaid telephone calling card industry. Typically, a phone card distributor negotiates with a long distance telephone service carrier for a long distance calling rate table from a particular region or country. Upon reaching acceptable terms, the long distance carrier provides the card supplier with an access number to be used for long distance calling and with PINs that-once activated-allow the caller to use the service. The distributor prints the access number, a pin number (generally concealed by a scratch-off band), dialing instructions, and other relevant information on a card to be used for long distance calling. Once an adequate number of cards are printed, the distributor ships these cards to resellers who activate the cards by submitting payment and providing the distributor with relevant information needed to identify the cards. Once activated, the reseller sends the cards to vendors who sell the cards for consumer use. Typically, phone cards are issued with fixed denominations, such as $5, $10, $20 and the like. When the vendor's supply of phone cards is depleted, he must order more cards from the reseller and wait for delivery. Invariably, there is a time delay between the time of shipment and delivery, thus resulting in significant amount of lost sales. Alternatively, the vendor may purchase more active cards than he expects to sell in any given time period so that he has a sufficient inventory in the event that the forecasted sales are exceeded for that particular time period. In this case, the vendor is required to pay for and store active cards which typically go unsold, thereby adding an obvious risks and financial exposure on the part of the vendor. While the known methods of distributing phone cards are of interest, they do not address the particular need to provide pre-paid card vendors with immediate access to a replenished supply of pre-paid cards when their inventory becomes depleted.

Additionally, there exist a variety of known devices for activating and validating pre-paid cards. Typically, these devices include an input means, such as an infrared reader, which obtain pre-paid card information and sends this information to a remote computer system for activation and validation. Accordingly, activation devices commonly require a modem and phone line. Activation and validation information are commonly stored on a database in the remote computer system. The pre-paid card information transferred from the vendor's activation device is compared to the information stored in the remote database for accuracy and validation. Assuming the pre-paid card information is accurate, the remote computer system activates the card. These activation procedures require expensive equipment and controlled environments which can only be used by those having phone lines available to them. As a result, there exist an untapped market, including street vendors and newspaper stands found in big cities, in which current activation devices cannot be used. While these known prepaid card activation devices are of interest, they do not address the particular need to provide an affordable, instant, on-site activation of pre-paid cards to the widest possible vendor base.

The Internet web site www.SpendCash.com discloses a method (InternetCash) for issuing and utilizing prepaid cards in both a traditional retail setting and in e-commerce (i.e., Internet purchases). More particularly, www.SpendCash.com discloses the use of pre-paid cards to purchase goods and services online from various Internet retailers. The prepaid cards are activated via a two step process at the vendor's location. The first step resembles the process used in the remote activation of prepaid phone cards, i.e. the vendor “swipes” the pre-paid card into a debit card/credit card terminal which in turn sends information relating to the card to a remote computer system. In the second step, the user who purchased this pre-paid card from the vendor must scratch off “gray material” on the back of the pre-paid card to obtain a “CARD ID” or PIN. To complete the activation of the pre-paid cash card, the user must then log on to the SpendCash website and enter a secret password to be associated with the CARD ID. Once the card is activated, the user is prompted to hyperlink to Internet web sites that accept the pre-paid card. Alternatively, the card holder may simply shop at one of the participating retail stores which accept InternetCash as a payment method. In order to use InternetCash, each participating web sites must be configured to accept the SpendCash pre-paid card as a form of payment. When a user wishes to make a purchase, he provides his pre-paid card information to the retail website from which he is making a purchase. Once the transaction is completed, the user may hyperlink to another website and make another, separate transaction. This process is cumbersome because it requires a user to enter into a series of separate transactions each time a purchase is made from a different retailer's web site. Additionally, retailers may be reluctant to adopt the SpendCash system since it requires them to adapt (i.e. re-program) their website to accept as payment SpendCash cards. Furthermore, a successful implementation of e-cash methods must rely on efficient widespread availability and activation of pre-paid cards, such as that accomplished by the PVD.

While the prior art is of interest, the known methods and apparatus present several limitations which the present invention seeks to overcome.

In particular, it is an object of the present invention to provide a method and apparatus for instant, on-site validation of pre-paid cards without the use of expensive equipment or telephone lines.

It is another object of the present invention to provide a method and apparatus for validating pre-paid cards which does not require remote communication with a central computer system for activation and validation.

It is another object of the present invention to provide a pre-paid card activation device having a low cost removable memory unit on which identification means may be stored.

It is another object of the present invention to provide a flexible and efficient method for redistributing unused PINs so as to minimize the financial exposure of all parties involved in the distribution of pre-paid cards.

It is another object of the present invention to provide an automated system capable of collecting, processing and displaying statistical sales data and calculating future sales forecasts based on this data.

It is yet another object of the present invention to provide an e-cash system and method for selling online, in a single pre-paid transaction, a plurality of goods and services from a plurality of Internet retailers at a single location.

It is another object of the present invention to solve the shortcomings of the prior art.

Other objects will become apparent from the foregoing description.

### SUMMARY OF THE INVENTION

It has now been found that the above and related objects of the present invention are obtained in a PVD for issuing, validating and implementing pre-paid cards fore use in both e-commerce and long distance calling applications. In particular, the PVD has a removable Memory Unit on which Personal Identification Numbers are stored. The method of the present invention provides for instant, on-site issuance of pre-paid cards which can be used in conjunction with a web-based system on which a card holder may purchase goods and services from a variety of retailers at a single location through a single transaction. Additionally, the pre-paid cards may be used as payment for long distance calls.

The present invention provides for a method of dividing and distributing PINs to a variety of point of sale managers. The PINs are distributed in such a manner so as to minimize the risk of loss for any party.

### BRIEF DESCRIPTION OF THE DRAWINGS

In the detailed description of the preferred embodiment, reference is made to the accompanying figures, wherein:

FIG. 1 represents a front view of the apparatus for issuing pre-paid cards of the present invention;

FIG. 2 is a flow diagram representing the method of distributing PINs in the present invention;

FIG. 3 is a block diagram showing the division and distribution of PINs by a Reseller;

FIG. 4 is a flow diagram representing the method of using the apparatus shown in FIG. 1;

FIG. 4A is continuation of flow diagram of FIG. 4, representing the method of issuing pre-paid e-cash cards using the apparatus of FIG. 1;

FIG. 4B is continuation of flow diagram of FIGS. 4 and 4A, representing the method of issuing pre-paid phone cards using the apparatus of FIG. 1;

FIG. 4C is continuation of flow diagram of FIGS. 4, 4A and 4B, representing the method of unlocking PINs using the apparatus of FIG. 1;

FIG. 5 is a flow diagram representing the method of implementing e-cash cards over a networked system such as an Internet web site;

FIG. 5A is a continuation of the flow diagram of FIG. 5;

FIG. 6 is a flow diagram representing the method of using and operating the networked system of FIGS. 5 and 5A;

FIG. 6A is a continuation of the flow diagram of FIG. 6; and

FIG. 6B is a continuation of the flow diagram of FIGS. 6 and 6A.

### DETAILED DESCRIPTION OF THE INVENTION

The present invention relates to a method and apparatus for storing, distributing and issuing pre-paid cards to be used for long distance calling (“phone cards”) and for selling goods and services in e-commerce to pre-paid card holders.

Generally, a pre-paid e-cash card has a PIN assigned thereto which corresponds to a dollar amount that may be used to purchases goods and services in e-commerce. Each time a purchase is made with the e-cash card, the purchase amount is deducted from the balance of the card. The method of activating and implementing these cards is described with detail herein.

Generally, a pre-paid phone card has a PIN assigned thereto which corresponds to a dollar amount which may be used to make long distance telephone calls. Each time a call is made with the phone card, the cost of the call is deducted from the balance of the card. The method of activating and implementing these cards is described with detail herein.

A PIN is a number or code that corresponds to a particular denomination of money. In the present invention, a PIN is printed on a card which is used to make payment for long distance calls and/or purchases of goods and services in ecommerce. These cards are commonly known as “pre-paid cards.” With respect to pre-paid calling cards, the PIN also corresponds to a particular long distance calling carrier (“Carrier”). For example, a PIN may correspond to $25 which may be used for long distance calling through a particular Carrier. Typically, a caller is required to dial the Carrier's toll free number and enter his PIN. The Carrier verifies that the PIN is valid and active, and connects the caller to the dialed destination. If the call costs $10, then that amount will be debited from the caller's PIN account. Therefore, the caller will have $15 remaining to make additional long distance calls. The card holder may make additional calls using that PIN until his PIN account balance reaches zero or the minimum amount required to make a phone call, at which point, the Carrier will not complete any more calls using that PIN.

E-cash cards use a PIN in a similar manner. Each time a purchase is made from an e-commerce retailer, the purchase amount is deducted from the e-card. For example, a user having a $100 pre-paid e-cash card may purchase a sweater costing $40 from an Internet clothing retailer. Therefore, $40 dollars is deducted from the card, leaving a $60 PIN account balance. The user may make additional purchases until the card's balance reaches zero or the minimum amount required to make a purchase, at which point, the card cannot be further used.

The following describes the hardware and software used in the present invention. In particular, a prepaid validation device (“PVD”), Memory Unit and software implemented therewith are described below.

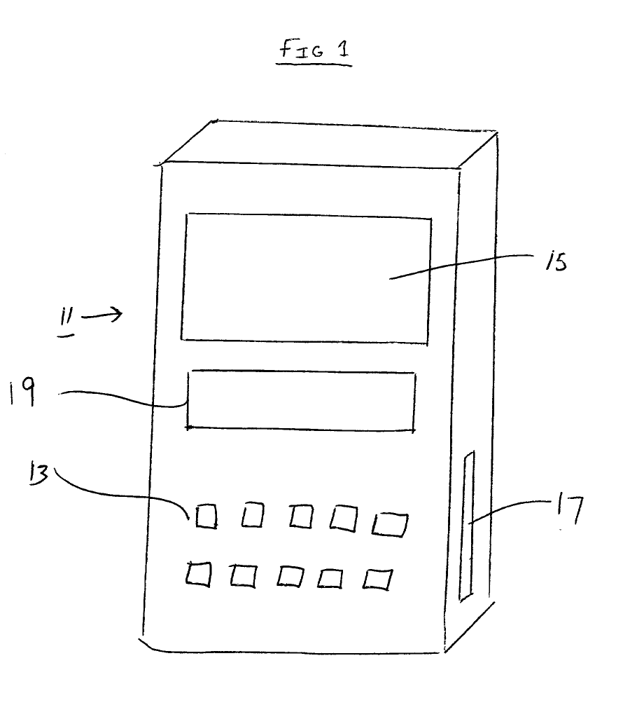

Referring to FIG. 1, a prepaid validation device (hereinafter, “PVD”) 11 is shown having an information input means 13, a display 15 for viewing information, and hardware 17 for printing a PIN and other information on pre-paid cards. The input means 13 may be a keypad, a voice recognition system, or any other input device. The PVD 11 further includes a removable Memory Unit 19 having eight megabytes of memory. It should be noted, however, the memory size of Memory Unit 19 may be larger or smaller according to the amount of information to be stored therein. A database of PINs is stored in the Memory Unit 19 in an encrypted format. As discussed below, the PVD 11 prints these PINs on cards to be used for long distance calling and/or purchasing goods and services in e-commerce.

In one embodiment, the PVD 11 is a handheld device weighing approximately 500 grams, having a LCD display, a backlit keypad and monochrome durable printing hardware. It should be noted that the PVD 11 may be any other memory device having printing capabilities, including but not limited to, a computer having a printer, label printer, tag printer and the like. The PVD 11 is equipped with a rechargeable battery pack and an A/C adapter. A removable Memory Unit 19 is provided with the PVD 11 and has stored thereon both active and inactive PINs to be printed on e-cash and phone cards. The PVD 11 is programmed with various applications to carry out the objects of the present invention. For example, the PVD 11 is programmed with a Security application, E-cash Card application, Phone Card application and Unlock PINs application. These applications are discussed with detail below. Additionally, the PVD 11 is programmed with a printing application for printing PINs on pre-paid cards. The PVD 11 also has a Sales History application for storing information relating to the sales of e-cash and phone cards. Each Memory Unit 19 has a pre-determined number of PINs which is projected by the Reseller based on forecasted sales data for a particular point of sale (POS) Manager. In projecting the sales, the Reseller may consider several factors, including but not limited to, the geographic region, prior sales history, and population of that region. Using this information, the Sales History application projects and updates future sales for a particular retailer. The PVD 11 may also be programmed with shortcut keys to facilitate a retailer's use. For example, a sequence of commands may be used to print the most frequently sold phone card or e-cash card, to display rates, or other information relating to the PINs of the PVD 11.

Having described the hardware and software implemented in the present invention, the method of organizing and distributing PINs is now described.

A Distributor may desire to sell pre-paid phone cards and e-cash cards. In the present invention, the Distributor must first obtain and/or generate a large quantity of Personal Identification Numbers (PINs) for those cards. Thereafter, the Distributor resells these PINs to Resellers, who in turn distribute them to retailers. Upon request and payment by a customer, the retailer prints a particular PIN on a pre-paid phone card or e-cash card. These steps are described in detail below.

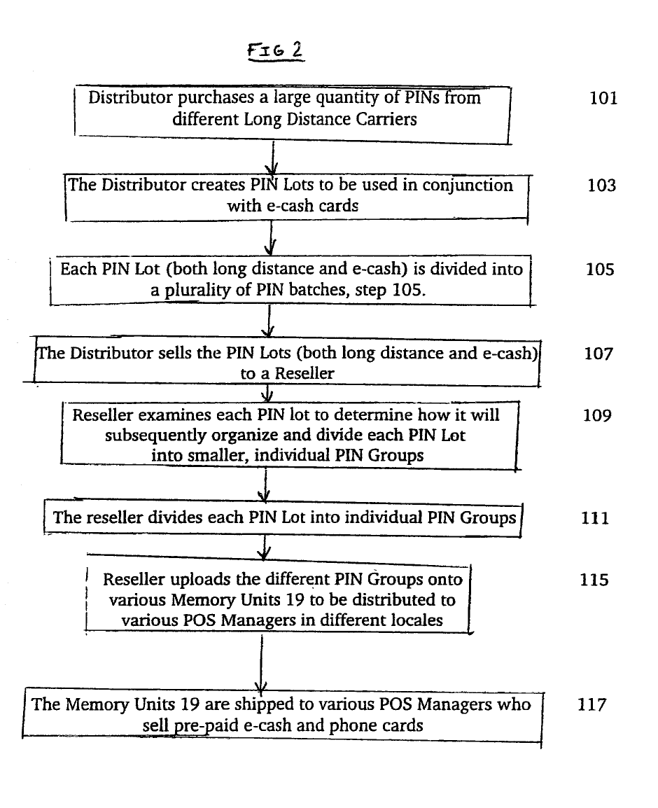

The method of distributing PINs is described below with reference to FIG. 2. To obtain PINs for pre-paid calling cards, the Distributor purchases a large quantity of PINs from different Long Distance Carriers, step 101. The Distributor should negotiate with each Carrier for the lowest long distance calling rates. These PINs will ultimately be used with pre-paid cards for long distance calling. The large quantity of PINs purchased from a Carrier is referred to as a “PIN Lot”. Each PIN Lot typically contains thousands of PINs, each of which corresponds to different dollar amounts that will be applied to long distance calls for the Carrier from which the lot was purchased. For example, a PIN Lot for Carrier X having 10,000 PINs may be divided so that 2500 PINs have a $10 value, 2500 PINs have a $25 value, 2500 PINs have a $75 value and 2500 PINs have a $100 value. Alternatively, each Lot may be for a single value. For example, a Lot of 10,000 PINs may all have a $10 value. It should be noted, however, that PINs may be associated with other values and PIN Lots may be divided differently from the example described above.

Similarly, the Distributor creates PIN Lots to be used in conjunction with e-cash cards, step 103. Each PIN Lot will contain a large quantity of PINs. As with the long distance PIN Lots, the e-cash PIN Lots may be divided into different dollars amounts. Alternatively, each Lot may be for a single value.

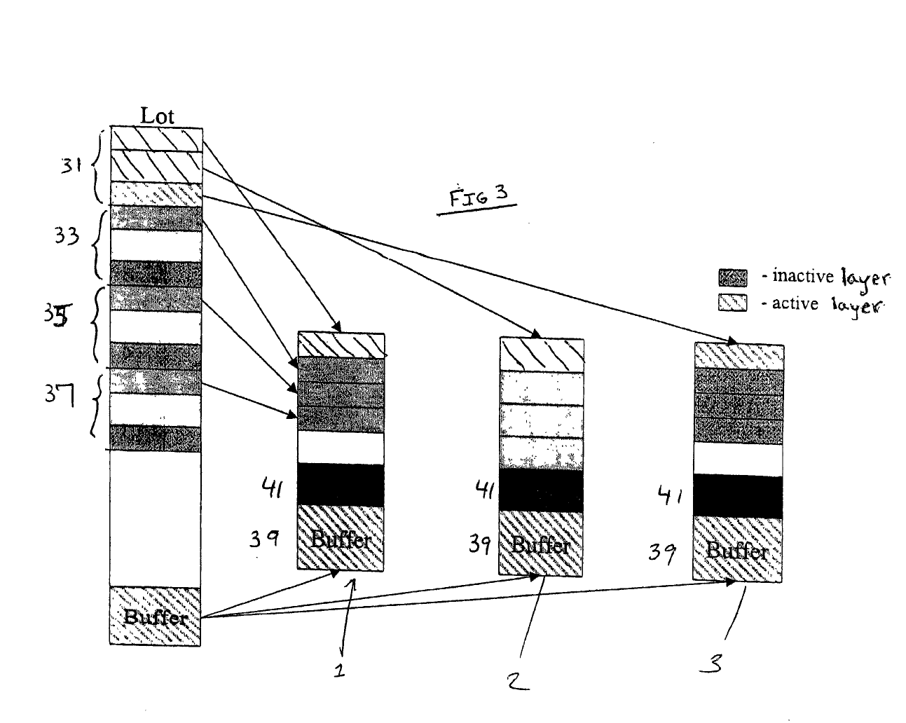

Each PIN Lot (both long distance and e-cash) is divided into a plurality of PIN batches, step 105. A PIN batch is a group of PINs that may be activated at one time. Since PIN batches from different long distance carriers will be stored on the Memory Units 19, it is possible that a PIN Batch for one particular Carrier may be sold at a different rate than the a PIN Batch for another particular Carrier. Likewise, the PIN Batch for each Carrier may vary in size as well. Accordingly, the Distributor should negotiate with the Carrier to divide each PIN Lot into PIN batches of appropriate sizes. A Distributor can easily determine the required PIN batch size through prior sales history and forecasted sales data provide to it by the Reseller. Batches are created to spread the risk of loss between the Reseller and Distributor, with neither party bearing the entire risk. In the prepaid industry, a Reseller pays for PINs before they are activated. Since PIN Lots are quite large (typically thousands of PINs), Resellers are typically reluctant to assume the risk of activating an entire PIN Lot at one time. Rather, Resellers are more willing to assume the smaller risk of activating a batch of PINs (typically hundreds of PINs) from PIN Lot at a single time. The Distributor, on the other hand, is reluctant to activate entire PIN Lots and cannot activate PINs individually to avoid obvious operational overload when dealing with a large number (thousands) of PIN activation requests (incidentally, the provider or Carrier itself would refuse such single-pin activation requests for the same reasons). By selling the PINs in batches, the distributor reduces its own risk of loss and minimizes operational costs. Therefore, PIN Lots are generally divided into batches, each of which is then activated separately rather than all at once. By this method, each party limits their risk of loss. Referring to FIG. 3, a PIN Lot is divided into five batches. As will be seen below, PINs from each batch are divided into individual PIN groups to facilitate the distribution and sale of PINs.

The Distributor sells the PIN Lots (both long distance and e-cash) to a Reseller, step 107, who in turn, re-distributes PINs to Point of Sale (“POS”) Managers. POS Managers are typically small retail businesses, such as newspaper stands, groceries, convenience stores, and the like. Since both PIN Lots and batches are typically large in size, a single POS Manager does not have the ability to sell an entire PIN Lot or batch within an acceptable period of time. Accordingly, the Reseller examines each PIN lot to determine how it will subsequently organize and divide each PIN Lot into smaller, individual PIN Groups, step 109. The reseller divides each PIN Lot into individual PIN Groups, such as PIN Groups 1, 2 and 3, step 111. Each of these PIN Groups are divided into multiple layers of PINs and distributed to various Memory Units 19, step 113. Preferably, each PIN Group has a total of four layers of PINs (i.e., a month's supply of PINs), with each layer containing a sufficient number of PINs for a week's worth of sales. Upon shipment of the PINs to a POS Manager, only the first layer of PINs is active. The remaining layers are inactive and can only be activated by the Unlock PINs procedure described below.

Referring to FIG. 3, the method of dividing and distributing PINs in a PIN Lot to form each individual PIN group is described. The PINs in the first batch 31 are divided and distributed to groups 1, 2 and 3, thus forming the first layer of each of those PIN Groups. Similarly, the PINs in the second batch 33 are divided and distributed into PIN Groups 1, 2, and 3, thus forming the second layer of pins in each of these PIN Groups. This process is repeated with respect to the third and fourth batches, 35 and 37, respectively, to form the third and fourth layers of groups 1, 2 and 3.

In addition to the four PIN layers, each individual PIN Group 1, 2, and 3 is provided with an active, but inaccessible, “Buffer” Layer 39 of PINs which may be used in the event that the POS Manager exceeds its forecasted sales for a given week. Each Memory Unit within the same distribution class is provided with the same Buffer PINs. The Reseller separates the Buffer PINs into segments of PINs, wherein the size and first PIN of a segment is defined by a soft code which is generated by the Reseller's software and is used to unlock the Buffer PINs via the “Unlock PINs” procedure described below. While the Buffer Layer 39 is not required for the operation of the present invention, its use is preferred because it enables the POS Manager to expand the supply of PINs in the active layer prior to the time the Reseller activates the next layer of inactive PINs. The Memory Units 19 may also contain an additional inactive “Promotional” PIN layer 41. Promotional PINs may be issued for events such as holiday sales, special discounts, competitive pressure, marketing purposes, etc., and are activated by the Unlock PINs process described below.

Each Reseller should maintain a system in which information relating to the PIN Lots, PIN Groups, Distributor and POS Manager is stored and processed. The Reseller's system may include, for example, a personal computer having a database application, a modem and a memory and read/write device. Software is used on the Reseller's system to facilitate the creation and distribution of PINs to Memory Units 19. For example, the Reseller's system should be programmed to upload and download PIN information and related sales data from Memory Units 19. Additionally, the Reseller's software should manage each POS Manager's Memory Unit 19 and account. The Reseller's system should also be programmed to compare a particular Carrier's rate tables associated with PINs stored on the Memory Units 19 to the Carrier's current rate tables stored on the Reseller's system. Furthermore, the system should generate soft codes to be used for unlocking PINs.

Additionally, the Reseller's system should run an application which manages the PIN Lots. For example, the Reseller's system should be programmed to view and maintain the status of PIN Lots and their breakdown. Additionally, the system should be programmed to facilitate activation requests for a specific batch of PINs. Likewise, the system should run software for dividing PIN Lots into PIN Groups, regular layers, Buffer Layers and Promotional Layers.

Finally, the Reseller's system should run software capable of maintaining information relating to PIN Lot Distributor. For example, the system should be programmed to view and maintain the status of activation requests made to a Distributor. Additionally, the system should be programmed to make activation requests, payments therefor and downloading activated batches.

As with the Reseller, the distributor should maintain a computer system to manage and oversee information relating to the Reseller, Lots and Carrier information (e.g. rate tables, access numbers, etc.). Software similar to that described with reference to the Reseller may be implemented.

Referring to FIG. 2, once the PIN Groups are created and stored on the Reseller's system, the Reseller uploads the different PIN Groups onto various Memory Units 19 to be distributed to various POS Managers in different locales, step 115. Each Memory Unit 19 may include a plurality of PIN Groups. For example, a Memory Unit 19 may have three different PIN Groups for three different long distance Carriers and another PIN Group for e-cash cards. This provides customers with flexible pre-paid card options. For example, customer may purchase a PIN for a particular carrier and a PIN for e-cash. These Memory Units 19 are shipped to the various POS Managers who sell e-cash cards and phone cards, step 117.

It should be noted that the PVD and PIN structures described herein are not limited to pre-paid calling card and e-cash services. In this regard, PINs may correspond to other types of information depending upon the nature of the use of the PINs. Accordingly, the PVD and PIN structure may be used in a variety of other fields, including but not limited to libraries, stores, pharmacies, hospitals, etc.

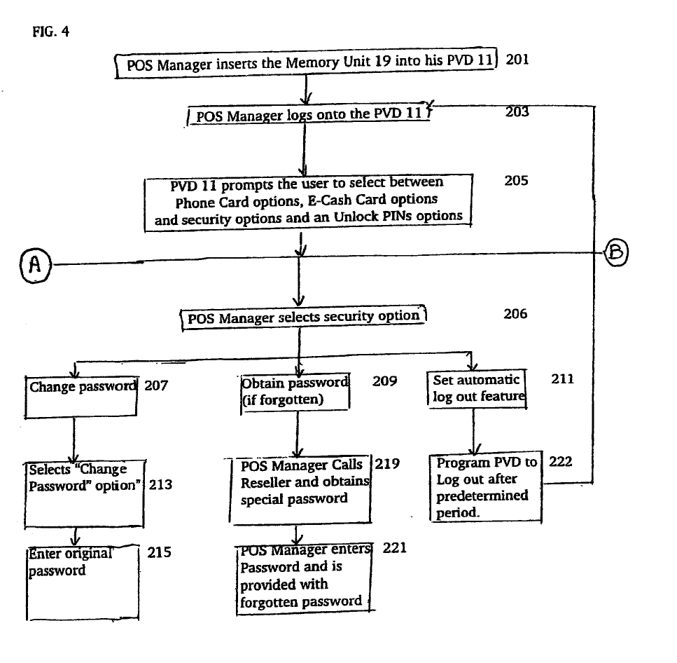

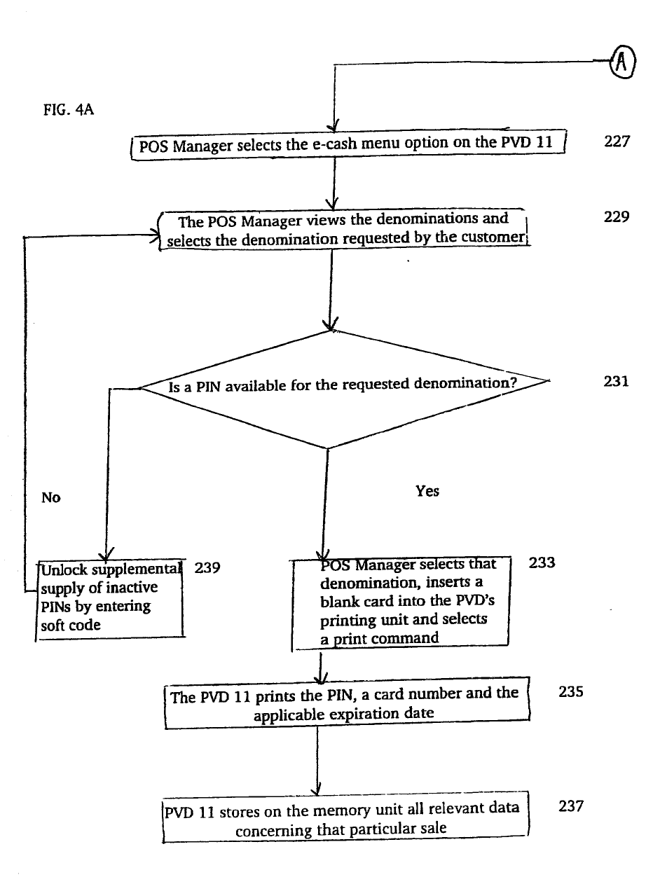

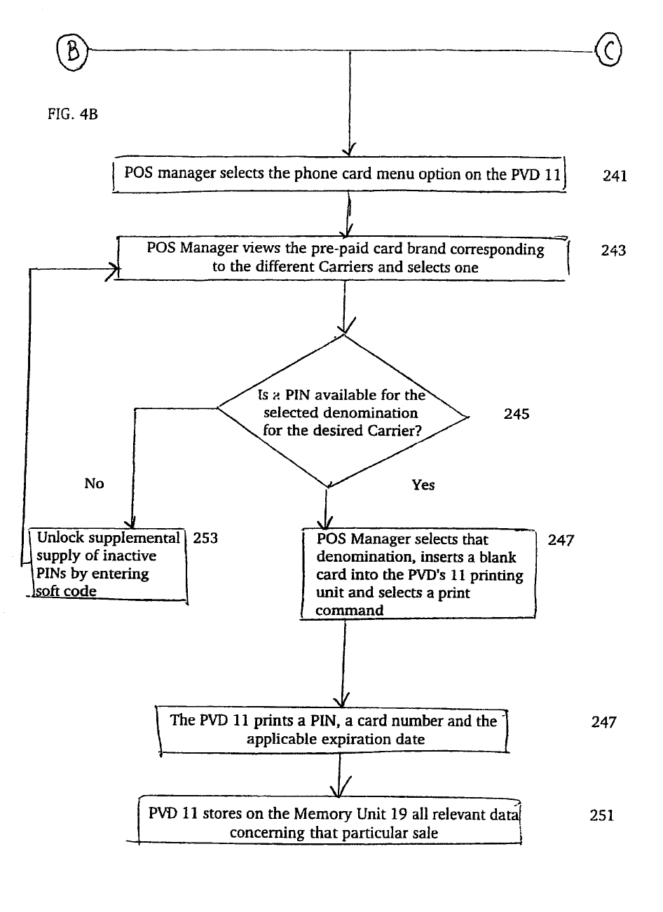

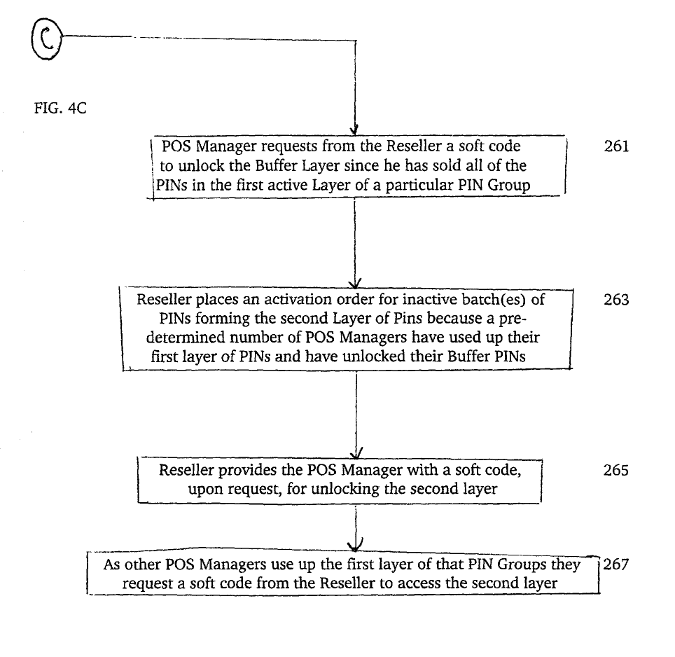

Having described the method of creating PIN Groups and Memory Units 19, the method of using the PVD 11 and issuing pre-paid cards is now described. Referring to FIG. 4, a POS Manager inserts the Memory Unit 19 into his PVD 11, step 201. The PVD 11 is controlled via user identification procedure. Each POS Manager is assigned a unique ID number and a unique password. The POS manager must input at some time before the sale transaction his identification and password information to gain access to the PVD 11 and Memory Unit 19. This provides a measure of security to prevent outsiders from tampering with the PVD 11 or fraudulently obtaining pre-paid cards.

Once the POS Manager is logged onto the PVD 11, step 203, the PVD 11 prompts the user to select between Phone Card options, E-Cash Card options and Security options and an Unlock PINs options, step 205.

Upon selecting Security options, step 206, the POS Mangers may change his password, step 207, obtain his password (if forgotten), step 209 or set an automatic log out feature, step 211. Each of these features are discussed below.

To change the password, the POS Manager selects the “Change Password” option under the Security options on the PVD 11, step 213. The POS Manager is prompted to enter his original Memory Unit 19 password, step 215. Upon entering the correct password, the user is then prompted to enter the desired password twice, step 217. The PVD 11 uses a well known procedure for changing a password.

The PVD 11 is also programmed to provide the POS Manager with his password in the event that it is forgotten. The POS Manager must call the Reseller and obtain a special password for a specific PVD 11, step 219. Upon entering this special password, the PVD 11 provides the POS Manager with his forgotten password, step 221. However, this special password cannot be used more than one time. If the POS Manager forgets his password again, he must call the Reseller and obtain a new password. The number of such attempts should be limited.

As a further security measure, the PVD 11 is programmed to log the POS Manager off of the PVD 11 after a preset period of inactivity, step 223. The POS Manager must log onto the PVD 11 once again and enter his Identification and password information, step 203. Using the E-cash card and Phone Card options on the PVD 11, the POS Manager may issue PINS and print them on these cards. The method of issuing each type of card is described below.

The method of issuing e-cash cards is now described with reference to FIG. 4A. A customer offers to purchase an e-cash card for a particular value from the POS Manager. The POS Manager selects the e-cash menu option on the PVD 11, step 227. E-cash cards may be issued in varying denominations, such as in $10, $25, $50 and $100 increments. Of course, other denominations may be used depending upon the customers' demands. The POS Manager views the denominations and selects the denomination requested by the customer, step 229. The PVD 11 searches the PIN Groups stored on the Memory Unit 19 to determine whether a PIN is available for the requested denomination, step 231. If a PIN is available, the POS Manager selects that denomination, inserts a blank card into the PVD's 11 printing unit and selects a pre-programmed print command, step 233. The PVD 11 prints the PIN, a card number and the applicable expiration date, step 235. The e-cash card may be used immediately, or alternatively, remain inactive until the user requests activation on a web-site, as described below. Upon completion of the transaction, the PVD 11 stores on the Memory Unit 19 all relevant data concerning that particular sale, step 237. This information may include the issued PIN, value, issue date, unit identification number and other relevant information.

If, on the other hand, all of the accessible PINs for the requested denomination have been already used, the POS Manager may unlock a supplemental supply of inactive PINs for that denomination by selecting the “Unlock PINs” option on the PVD 11 menu and entering a soft code obtained the Reseller, step 239. Prior to issuing the soft code, the Reseller may use option software to determine what type of PINs should be unlocked (i.e., regular PIN Layers, Buffer PINs, and Promotional PINs). The Reseller selects the types of PINs to be unlocked and issues the soft code to the POS Manager. Once the PINs are unlocked, the PVD 11 is used to issue the e-cash card using the activation steps described above, steps 229 through 237.

As noted herein, a plurality of Memory Units 19 share the same Buffer PINs. However, the Buffer PINs can only be accessed by obtaining a soft code from the Reseller. The Buffer PINs are divided into segments of PINs, with the size and first PIN of each segment defined by the soft code. Thus, the soft code will be different for other POS Managers. As a result, the POS Manager who requested the soft code is the only party who can ever unlock these PINs. When another POS Manager requests to unlock the Buffer PINs, a new soft code corresponding to the first PIN in the next available segments of Buffer Pins is issued to that POS Manager.

Referring to FIG. 4B, the method of issuing a phone card is now described. A customer offers to purchase a phone card for a particular value. The POS manager selects the phone card menu option on the PVD 11, step 241. Phone cards may be issued in varying brands and denominations. Accordingly, the Memory Unit 19 has PINs corresponding to a variety of Long Distance Carriers stored therein. Under the Phone Card options on the PVD 11, the POS Manager views the pre-paid card brand corresponding to the different Carriers and selects one, step 243. The PVD 11 checks the Memory Unit 19 to determine whether a PIN is available for the selected denomination for that particular Carrier, step 245. If a PIN for the requested denomination is available, the POS Manager selects the denomination and inserts a blank card into the PVD's 11 printing unit and selects a pre-programmed print command, step 247. The PVD 11 prints a PIN, a card number and the applicable expiration date, step 249. The card is now ready for use. Upon completion of the transaction, the PVD 11 stores on the Memory Unit 19 all relevant data concerning that particular sale, step 251. This information may include the issued PIN, value, issue date, unit identification number and other relevant information.

If, on the other hand, all of the PINs for the selected denomination have already been used, the POS Manager may gain access to a supplemental supply (i.e., regular PIN Layers, Buffer PINs or Promotional PINs) of inaccessible PINs for that denomination of the particular Carrier using the unlocking procedure described above, step 253. Once the PINs are unlocked, the PVD 11 notifies the POS Manager that the PINs are now available for sale. The POS Manager may then issue the phone card using the validation steps described above, steps 243-251.

Additionally, the PVD 11 may be programmed to search the database of phone card PINs for the least cost of long distance calling for the various service providers and corresponding PINs. The PVD 11 then displays the PIN with the lowest long distance rates. A card is issued using the printing procedures described above.

Referring to FIG. 4C, the method of activating an inactive layer of PINs and the risks associated therewith is now described.

A Plurality of PIN Groups are generated from a single PIN Lot. Thereafter, each of these PIN Groups are uploaded to different Memory Units 19. Furthermore, each Memory Unit 19 may have stored thereon additional PIN Groups which were generated from other PIN Lots (i.e., other Carriers or different denominations). As discussed herein, only the first layer of PINs for each PIN Group stored on a Memory Unit 19 is activated. The remaining layers are inactive and can only be activated by submitting payment and placing an additional order. When a POS Manager has sold all of the PINs in the First Layer of a particular PIN Group, he may request from the Reseller a soft code to unlock the Buffer Layer, step 261. When a certain number of POS Managers have used up their first layer and have unlocked their Buffer PINs, the Reseller places an activation order for the batch(es) of PINs forming the second Layer of PINs, step 263. By doing this, the Reseller has effectively activated the second layer of PIN Groups for all other Memory Units 19 having PIN Groups generated from the second batch. Once the second batch of PINs is activated, the Reseller provides the POS Manager with a soft code, upon request, for unlocking the second layer, step 265. As other POS Managers use up the first layer of that PIN Groups, they may request a soft code from the Reseller to access the second layer, step 267.

While some POS Managers may have already sold all of the PINs in the first layer of PIN Group, other POS Managers may sell the PINs from that layer at a slower pace. There exists a distinct possibility that some POS Managers may never request the activation of the second layer. This is a risk of loss that the Reseller must assume. However, these PINs may be recycled at a later time for other uses, thereby minimizing the Reseller's financial exposure. For example, the Reseller may create a pool of unused PINs which may be distributed at a later date. Alternatively, the Reseller may place unused active PINs in the Buffer PINs database which may be uploaded to Memory Unit 19 in the next delivery cycle. This enables the Reseller to recapture some of his lost revenue at a future date.

Turning to an example, a first POS Manager having a first Memory Unit may have used up all of the PINs in the first Layer of the PIN Group generated from Lot 1. Meanwhile, a second POS Manager having a second Memory Unit may still be selling PINs from the first Layer of the PIN Group generated from Lot 1. Since the first POS Manager and other POS Managers have already activated their Buffer PINs, the Reseller activates the second Layer and provides the first POS Manager, upon request, with a soft code to unlock the second Layer. The first POS Manager must pay the Reseller for the activation of the second Layer. However, the second POS Manager does not sell all of the PINs in the first Layer and never requests activation of the second Layer. Therefore, the Reseller cannot charge the second POS Manager for the PINs in the second Layer. As a result, the Reseller loses his investment in these PINs since he has already paid the distributor to activate them. However, the Reseller may recover at least a portion of his investment by using the recycling procedures described above.

When the last layer of PINs stored on the Memory Unit 19 runs low, the PVD 11 prompts the POS Manager to order a new Memory Unit. The POS Manager may do this by contacting the Reseller and requesting new PINs. The Reseller divides the next of PIN Lot using the methods described herein and downloads the various PIN Groups onto the Memory Units 19. The Memory Units 19 are shipped to the POS Manager who may continue to use his old Memory Unit until the remaining PINs are depleted, or alternatively, may begin using the new Memory Unit immediately.

As discussed herein, prior pre-paid card systems require retailers to contact the Reseller, via a modem or other remote linkage, to receive PIN validation from prior to selling a pre-paid card. Therefore, customers are often required to wait while the retailer receives such approval. The present invention, on the other hand, uses Memory Units which provide for already active and valid PINs, thereby eliminating the need to obtain PIN validation each time a card is sold. Therefore, pre-paid cards may be sold in a more efficient manner whereby a user may purchase goods and/or services from various Participating Merchants without the need to the enter personal information each on any of the Participating Merchants web sites.

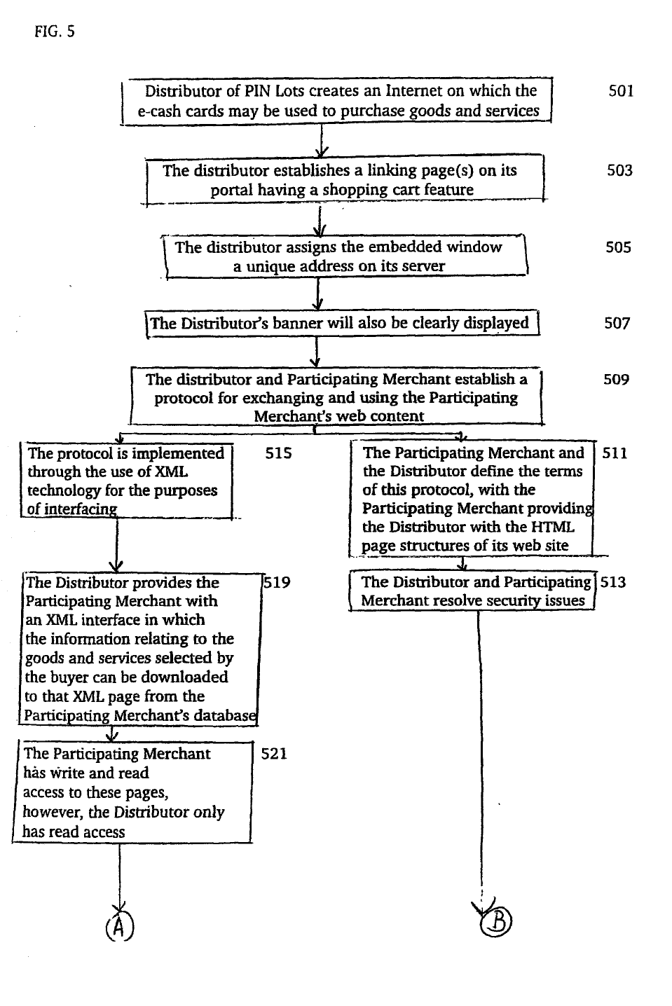

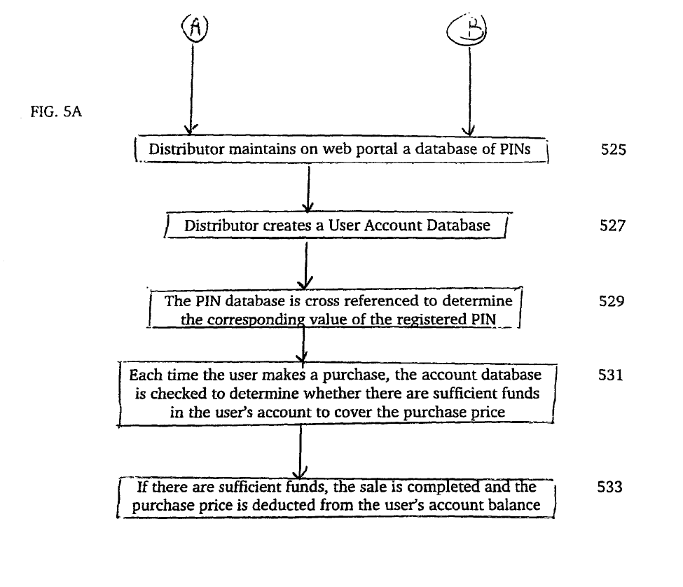

Having described the method and apparatus for issuing prepaid e-cash cards, the method of implementing these cards on the Distributor's system is now described with reference to FIG. 5.

In addition to creating e-cash PIN Lots, the Distributor also creates an interactive system on which the e-cash cards may be used to purchase goods and services, step 501. In the preferred embodiment, the system is maintained on the Internet and the system is implemented in the form an e-commerce based Internet web portal. It should be noted however, that the system of the present invention may be maintained on other networked environments, including but not limited to, Intranets, telephone networks, wireless networks and other known or hereinafter developed networks.

On its system, the Distributor sells to e-cash card holders the goods and services of a plurality of other commercial wholesalers and retailers. These other commercial wholesalers and retailers may include, but are not limited to, clothing retailers, music retailers, electronics retailers and the like (collectively referred to as, “Participating Merchants”). Accordingly, the Distributor must first negotiate with each Participating Merchant to purchase their goods and services at wholesale or discounted prices.

In the present invention, the Participating Merchants do not sell their items directly to e-cash card holders and, unlike the prior art, the Participating Merchants are not required to adapt their web sites to accept e-cash as a form of payment for its goods and services. Rather, the Distributor provides a service to both the Participating Merchants and the card holders, operating as a new channel for e-commerce based on a prepaid payment methodology. Additionally, the e-cash card holders are not required to enter their personal information (e.g. name, shipping address, etc.) each time they wish to purchase a Participating Merchant's goods. Rather, the present invention provides for the sale of a variety of goods and services from a variety of Participating Merchants under a single transaction where payment is processed at a single location, i.e, the Distributor's portal .

In the present invention, the card holder uses the distributor's web site to view and purchase goods displayed on the web site of a particular Participating Merchant. More particularly, the distributor establishes a linking page(s) on its portal having a shopping cart feature, step 503. The use of shopping carts in e-commerce is a well known method. The linking page(s) implement a hyper-linking feature capable of linking the buyer to an embedded window on the distributor's web site. The hyperlinking feature may be a button or other means that may be clicked via a mouse. The embedded window is a page on the distributor's web site which contains the content of the particular Participating Merchant's e-commerce website, including the goods and services, pricing information, product information and other relevant information on that Participating Merchant's web site. The embedded window is essentially a mirror image of the Participating Merchant's web pages from their web site. However, the embedded window does not have the same URL address as the Participating Merchant's web site. Rather, the distributor assigns the embedded window a unique address on its server, step 505. As a result, the card holder may view the content of the Participating Merchant's web site through the embedded window on the Distributor's web site, just as if they were actually at the Participating Merchant's web site. However, it will be apparent to the card holder that he is not at actually at the Participating Merchant's web site, but rather at the Distributor's embedded window, as the Distributor's banner will also be clearly displayed, step 507. As the buyer navigates on the Participating Merchant's site, the window layout changes, including its embedded information, but the page banner on the distributor site remains the same. When the buyer decides to purchase a service or a product from the Participating Merchant's site, he uses the shopping cart feature on the Distributor's web site. The distributor's server functions as a Proxy server positioned between the client (card holder) and the server(s) (Participating Merchant(s)), enabling the card holder to access the Participating Merchant's goods and services on the Distributor's web site, rather than at the Participating Merchant's site.

The distributor and Participating Merchant must establish and adhere to a protocol for exchanging and using the Participating Merchant's web content, including product or service information such as quantity and pricing information, step 509. This protocol must identify the page layout structure as well as the dynamic page loading sequence on the Participating Merchant site. Since, there are no general standards for creating HTML dynamic pages, the protocol may vary from one Participating Merchant to another. Accordingly, the Participating Merchant and the Distributor define the terms of this protocol, which requires the Participating Merchant to provide the Distributor with the HTML page structures of its web site, step 511. Using this information, the Distributor will be able to create the embedded window on its web site. To the extent that security issues exist with respect to the Participating Merchant's HTML page structure, the Distributor and Participating Merchant should resolve these issues to ensure that the integrity and validity of this information is preserved, step 513.

Alternatively, the protocol may be implemented through the use of XML technology for the purposes of interfacing, step 515. In this case, the Distributor may provide the Participating Merchant with an XML interface in which the information relating to the goods and services selected by the buyer can be downloaded to that XML page from the Participating Merchant's database, step 519. Accordingly, the Participating Merchant will have write and read access to these pages, however, the Distributor will only have read access to these pages, step 521. A Secure Socket Layer (SSL) protocol may be used to maximize security. The XML technology is used to upload shipping information to the Participating Merchant's database from the distributor's site. Although the Participating Merchant will handle the shipping of the purchased items, the buyer will be able to track these items on the Distributor's web site, step 523.

The method described above requires the Participating Merchant and Distributor to enter into an agreement, whereby the Participating Merchant authorizes the Distributor to include its web content on the Distributor's embedded window. However, a card holder may desire to purchase goods and services from a particular Merchant which has not entered into such an agreement with the Distributor. In this case, the Distributor's server will notify the user that the selected merchant is not a Participating Merchant, and therefore, its goods and services cannot be purchased through the Distributor's system. Since the merchant does not accept e-cash as payment, the user must purchase those items from the merchant's web site, through the use of credit cards or other payment means. Accordingly, the user may exit the Distributor's web site and shop at that merchant's web site. As a courtesy to the user, the Distributor may link the user to that web site. Before linking the user to that web site, the Distributor may aks the user if it would be interested in having that merchant added as a Participating Merchant. Using this information, the Distributor may approach that merchant to inquire whether it would be interested in becoming a Participating Merchant. On the other hand, the user may continue shopping on the Distributor's system for other items. In this case, the user may search for similar goods and services offered on the Distributor's system by the Participating Merchants. To facilitate this search, the Distributor may ask the user what type of goods or services they are looking for, preferred prices and other relevant information. The Distributor's system will then spawn a search in its database of Participating Merchants for the goods requested by the user and provide this information to the user. The user may then select the goods and services from the Participating Merchant which most closely matches its criteria.

In the present invention, the Distributor must maintain on its system a database of PINs, step 525. This database is generated from the PIN Lots (created earlier by the Distributor) and includes the corresponding value for each PIN. A user account database is also created, step 527. When a user registers a PIN account (as described below), the PIN database is cross referenced to determine the corresponding value of the registered PIN, step 529. Thereafter, the PIN is activated and will be associated with the user's account in the account database. Each time the user makes a purchase, the account database is checked to verify that there are sufficient funds in the user's account to cover the purchase price, step 531. If there are sufficient funds, the sale is completed and the purchase price is deducted from the user's account balance, step 517. Similarly, each time a new PIN is added to the user's account, the account database is updated by adding the PIN value to the user's account balance. This new PIN will also be associated with the user's account. The information on this database is used to validate PIN information and verify that there are sufficient funds available for that particular PIN.

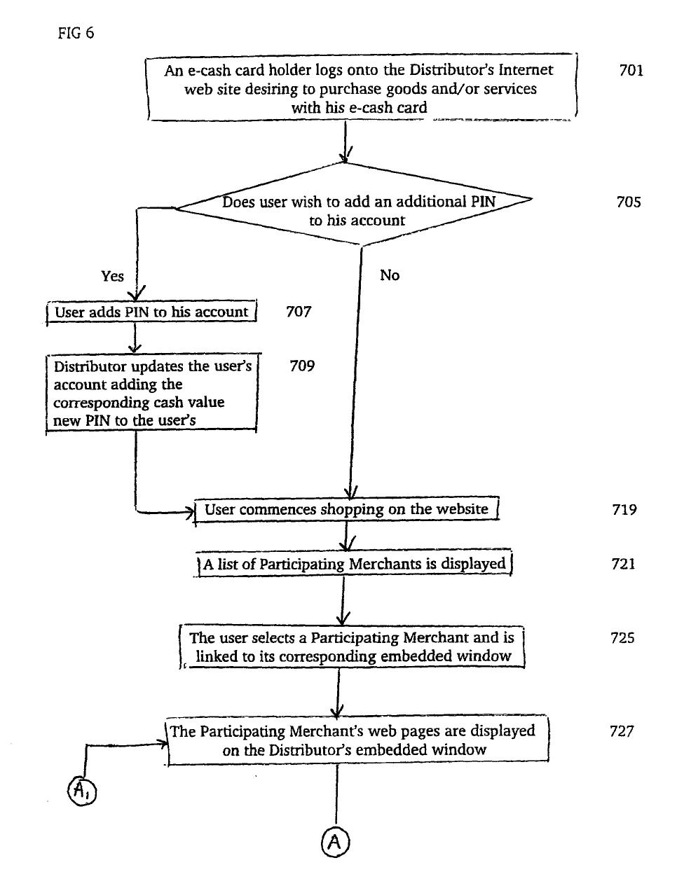

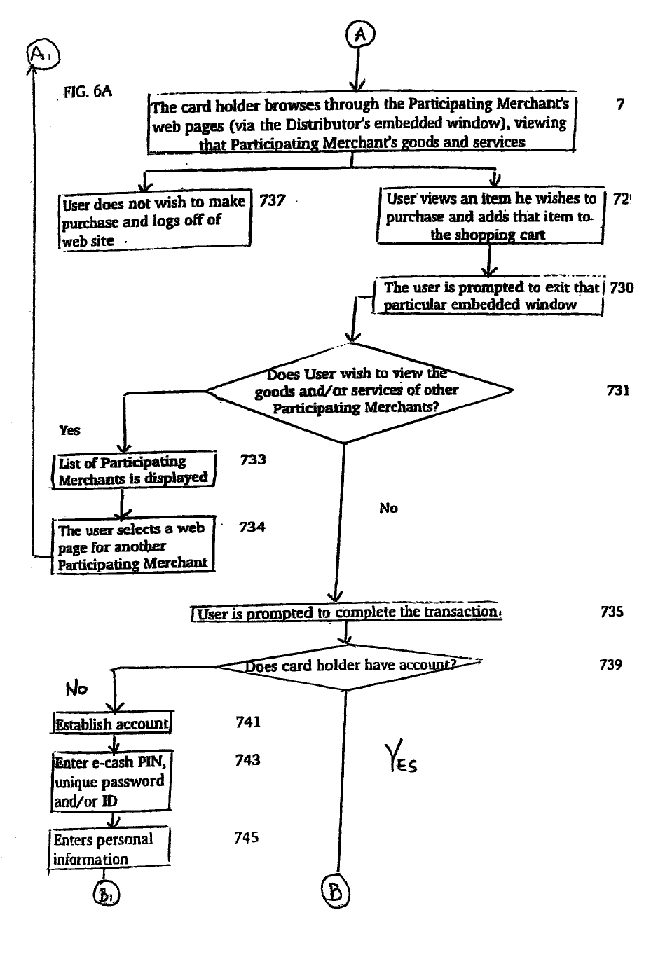

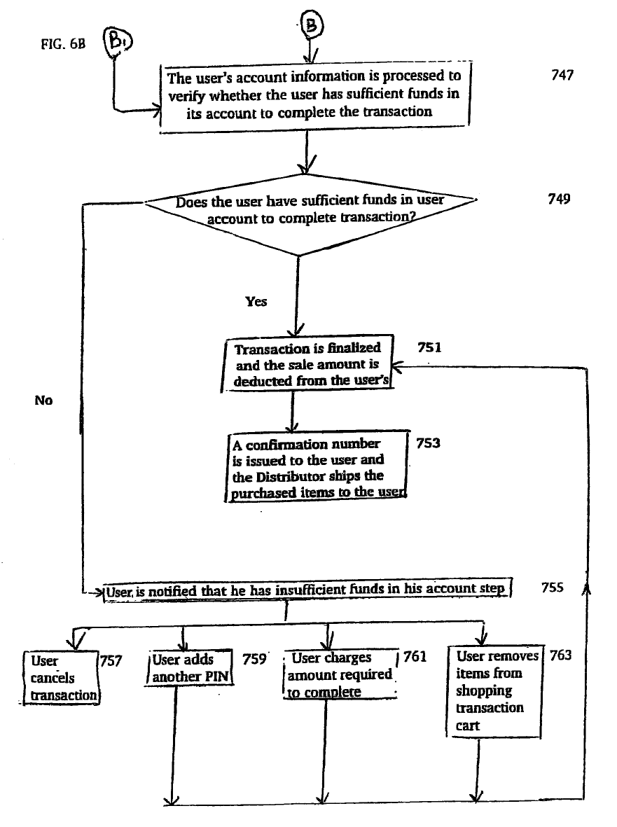

Referring to FIG. 6, the operation of the user's system is now described where the system is implemented in the form of an Internet web portal. An e-cash card holder links to the Distributor's Internet web site desiring to purchase goods and/or services with his e-cash card, step 701. Upon entering the web site, the user is asked whether he would like to add an additional PIN to his account (if the user has already has an account), step 705. If the user has purchased an additional e-cash card, he may add that card's PIN to his account by entering the PIN printed on that card, step 707. The Distributor updates the users account by adding the corresponding cash value of the new PIN to the user's remaining balance, step 709, and the user may begin shipping, step 719. If, on the other hand, the user has not purchased an additional ecash card or does not have an account, he may begin shopping on the website, step 719. It should be noted that the user may add a PIN at any time while visiting the web site.

An additional form of payment is provider for the user's convenience. Conventional credit cards may be used when the user's e-cash card balance is insufficient to cover the cost of the transaction. In this case, the user may charge the difference on his credit card.

A list of Participating Merchants is displayed, i.e., the list of links to the embedded windows on the Distributor's which correspond to each Participating Merchant, step 721. The user selects a Participating Merchant and is linked to its corresponding embedded window, step 725. The Participating Merchant's web pages are displayed on the Distributor's embedded window (i.e., as if the card holder is looking through a window into the e-store of the participating merchant), step 727. The card holder browses through the Participating Merchant's web pages (via the Distributor's embedded window), viewing that Participating Merchant's goods and services as if he was purchasing these items directly from the merchant's site, step 728. When the user views an item he wishes to purchase, he simply adds that item to the shopping cart provided by the Distributor, step 729. Should the user change his mind with respect to any items in his cart, he may remove these items at any time. When the user has finished viewing and selecting items on the Participating Merchant's web page, he is prompted to exit that particular embedded window, step 730. Next the card holder is asked whether he would like to view the goods and/or services of other Participating Merchants, step 731. If the user wishes to view another Participating Merchant's items, then the list of Participating Merchants is displayed once again, step 733. The user selects another Participating Merchant, step 734, and shops for items in the manner described herein, steps 727-731.

If, on the other hand, the user does not wish to view any other Participating Merchants items, then the user is prompted to complete the transaction by approving the items for final sale, step 735. If the user has not selected any items, then he me simply leave the Distributor's web site, step 737.

To finalize his purchase, the card holder must have previously established a user account. Therefore, when the card holder wished to finalize his purchase, he is asked whether he has a user account, step 739. If the card holder does not have a user account, then he is prompted to establish one, step 741. The user may do this by entering his e-cash PIN and selecting a unique password and/or identification code (“ID”), step 743. Additionally, the card holder should enter personal information, including his phone number, e-mail address and address to which purchased products may be delivered, step 745. The user may optionally enter credit card information in the event that he chooses to pay for the goods in this manner. Once the card holder has established an account (or the user already has an account), his account information is processed to verify whether the user has sufficient funds in its account to complete the transaction, step 747. The account database is examined to determine whether the user has sufficient funds in its account, step 749. If the user has sufficient funds, the transaction is finalized and the sale amount is deducted from the user's account, step 751. Once the sale is finalized, a confirmation number is issued to the user and the Distributor ships the purchased items to the user, step 753. If the user has insufficient funds in its account, then the user is so notified, step 755. In this case, the user may cancel the transaction, step 757, add another PIN to its account so that it has sufficient funds, step 759, charge the amount required to complete the transaction to his credit card, step 761, or remove items from the shopping cart so that it has sufficient funds to purchase the remaining items in the shopping cart, step 763. If the user removes the items from the shopping cart, charges the difference or adds a PIN, the transaction is completed using steps 751 and 753.

As can be seen from the foregoing description, the Distributor's portal is the only location where an e-cash card holder enter personal information to purchase the goods and/or services of different Participating Merchants. As a result, the sale of these goods is completed in a more efficient and anonymous manner.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims and not by the foregoing specification.

What is claimed is:

1. An apparatus for issuing pre-paid cards comprising:
an input means for entering information into said apparatus;
a display for viewing said information;
a removable memory unit having a database of PINs stored thereon, said PIN database having at least one PIN group stored therein,
each PIN group having a plurality of layers, wherein the first layer is initially activate and the remaining layers are inactive;
means for searching the database to determine whether PINs are available in said active layer;
means for selecting and issuing PINs to said pre-paid cards;
means for unlocking said inactive PIN layers; and
a printer for printing said PINs on said pre-paid cards.

2. The apparatus of claim 1, further comprising
security means for providing a user access to said apparatus wherein said security means is configured to require a password and identification code for accessing said apparatus;
means for storing sales related information on said apparatus;
said plurality of PIN Groups further comprises PINs to be used for purchasing goods and services on a networked system and PINs to be used for calling applications; and
and said apparatus is a hand held unit.

3. The apparatus of claim 2, wherein
each of said PIN Groups further comprises a buffer layer of PINs and a promotional Layer of PINs;
said means for unlocking said inactive PIN layers is a soft code generated by a supplier of said memory unit;
said security means further comprises a means for changing said password, means for recalling a forgotten password, and means for logging a user off of said apparatus after a pre-determined period of inactivity;
said means for searching the database further comprises a means for determining least cost routing of said phone PINs; and
said networked system is an Internet web site.

4. A method for dividing and distributing PINs to be sold for use with pre-paid cards comprising the steps of:
obtaining PIN lots containing a variety of PINs to be used in conjunction with said pre-paid cards;
dividing each of said PIN lots into a plurality PIN batches, wherein each PIN batch comprises a plurality of PIN layers;
distributing said PIN lots to a plurality of resellers,
activating the first of layer of PINs in said first PIN batch;
distributing PINs from said first PIN batch to a plurality of PIN groups, forming a first layer in each of said PIN groups; and
distributing PINs from the remaining PIN batches of each PIN lot to said plurality of PIN Groups, forming a plurality of remaining layers in each of said PIN groups wherein said plurality of remaining layers in said PIN groups are inactive.

5. The method of claim 4, further comprising the steps of:
uploading each of said PIN groups onto a variety of memory units to be distributed to point of sale pre-paid card managers;
generating a soft code for unlocking the remaining layers of PINs. distributing said memory units to a plurality of point of sale pre-paid card managers; and
selling and issuing pre-paid cards having said PINs stored on said memory units.

6. The method of claim 5, further comprising the steps of:
distributing an active, but inaccessible, buffer layer of PINs to each of said PIN Groups;
generating a soft code for unlocking said buffer layer of PINs;
distributing an inactive promotional layer of PINs to each of said PIN groups; and
generating a soft code for unlocking said promotional layer of PINs.

7. The method of claim 6, further comprising the steps of:
storing information relating to said PIN Groups on the reseller's computer;
activating an inactive layer of PINs when said first active layer of PINs has been depleted by a pre-determined number of point of sale managers; and
issuing said soft code to the point of sale managers for activation of said inactive layer of PINs.

8. A method for distributing pre-paid PINs and implementing said pre-paid cards over a networked system comprising the steps of:
obtaining PIN lots containing a variety of PINs to be used in conjunction with said pre-paid cards;
dividing each of said PIN lots into a plurality PIN batches, wherein each PIN batch comprises a plurality of PIN layers;
distributing said PIN lots to a plurality of resellers,
distributing by each reseller said PINS from said PIN Lots to a plurality of PIN groups;
uploading each of said PIN groups onto a variety of memory units to be distributed to point of sale pre-paid card managers;
distributing said memory units to the point of sale managers for use in conjunction with an apparatus for issuing pre-paid cards;
maintaining a networked system over which goods and services are sold;
maintaining and updating on said networked system a database of said previously distributed PIN Lots;
creating and updating a user account database on said networked system wherein users of said networked system may store a PIN from a previously purchased pre-paid card;
displaying and selling on said system goods and services from a plurality of participating merchants; and
accepting as payment said pre-paid cards and corresponding PINS.

9. The method of claim 8, wherein said networked system is an Internet web site and said PIN groups comprise both PINS for purchasing goods and services on said Internet web site and PINS for making telephone calls.

10. The method of claim 9, wherein said step of distributing PINS from each PIN layer to a plurality of PIN groups further comprises the steps of
distributing PINS from said first PIN batch to a plurality of PIN groups, forming a first layer in each of said PIN groups;
distributing PINS from the remaining PIN batches of each PIN lot to said plurality of PIN Groups, forming a plurality of remaining layers in each of said PIN groups wherein said plurality of remaining layers in said PIN groups are inactive.

11. The method of claim 9, said step of creating and updating a user account further comprises the steps of:
storing, in said user account, a PIN registered by a user, the value of said PIN, and the user's delivery address;
updating said the user's account each time a purchase is made wherein the purchase price is deducted from the user's account;
updating said user's account each time a PIN is added to the user's account; and
generating soft codes for unlocking said inactive PIN layers.

12. The method of claim 8, further comprising the step of creating embedded windows for each of said participating merchants.

13. The method of claim 12, wherein said embedded windows comprises the content of each of said participating merchants web sites and said distributor's banner.

14. The method of claim 13, further comprising the step of establishing a protocol with said participating merchants for creating said embedded windows.

15. The method of claim 14, wherein said step of establishing a protocol further comprises the steps obtaining from said participating merchants the structure of said participating merchant's web site.

16. The method of claim 14, wherein said step of establishing a protocol further comprises the step implementing XML for downloading an XML page from said participating merchant's web page.

17. The method of claim 16, further comprising the step of implementing a secure socket layer in said protocol.

18. The method of claim 13, further comprising the steps of
inquiring whether non-participating merchants would like to become participating merchants; and
assisting the user in searching for goods or services which it wishes to purchase, comprising the steps of
obtaining from the user information relating to the goods and services which they would like to purchase,
searching by the distributor its database of Participating Merchants, and
providing the user with a list of goods and services which closely match the information obtained from said user.

19. The method of claim 11, wherein said step of accepting as payment said prepaid cards further comprises the steps of reviewing the user's account each time a purchase request is made by the user and determining whether the user has sufficient funds in the user's account to complete the transaction.

20. The method of claim 19, further comprising the steps of authorizing the sale if the user has sufficient funds in the user account for the transaction.

21. The method of claim 19, further comprising the steps of denying the sale if the user has insufficient funds in the user account for the transaction and permitting the user to remove items that it requested to purchase until the user has sufficient funds in the user account to complete the transaction.

22. The method of claim 21, further comprising the step of accepting a credit card payment as a substitute for said pre-paid cards.

23. The method of claim 21, further comprising the step of providing a shopping cart on said Internet web site in which the user may store items that the user wishes to purchase until the actual transaction is completed.

24. A method of selling goods and services on a networked system comprising the steps of:
maintaining and updating on said networked system a database of PINS previously distributed to point of sale pre-paid card managers, wherein said managers issue said PINS to pre-paid e-cash cards;
creating and updating a user account database on said networked system wherein users of said networked system may store a PIN from a previously purchased pre-paid e-cash card, said PIN corresponding to a particular cash value;
displaying embedded windows for a plurality of merchants; and
accepting as payment said pre-paid cards and corresponding PINS.

25. The method of claim 24, wherein said networked system is an Internet web site and said PIN groups comprise both PINS for purchasing goods and services on said Internet web site and PINS for making telephone calls.

26. The method of claim 25, wherein said embedded windows comprises the content of each of said participating merchants web sites and said distributor's banner.

27. The method of claim 26, further comprising the step of establishing a protocol
with said participating merchants for creating said embedded windows.

28. The method of claim 27, wherein said step of establishing a protocol further comprises the steps obtaining from said participating merchants the structure of said participating merchant's web site.

29. The method of claim 27, wherein said step of establishing a protocol further comprises the steps implementing XML for downloading an XML page from said participating merchant's web page.

30. The method of claim 29, further comprising the step of implementing a secure socket layer in said protocol.

31. The method of claim 30, further comprising the steps of
inquiring whether non-participating merchants would like to become participating merchants; and
assisting the user in searching for goods or services which it wishes to purchase, comprising the steps of
obtaining from the user information relating to the goods and services which they would like to purchase,
searching by the distributor its database of Participating Merchants, and
providing the user with a list of goods and services which closely match the information obtained from said user.

32. The method of claim 26, said step of creating and updating a user account further comprises the steps of:
storing, in said user account, a PIN registered by a user, the value of said PIN, and the user's delivery address;
updating said the user's account each time a purchase is made wherein the purchase price is deducted from the user's account;
updating said user's account each time a PIN is added to the user's account; and
generating soft codes for unlocking said inactive PIN layers.

33. The method of claim 32, wherein said step of accepting as payment said pre-paid cards further comprises the steps of reviewing the user's account each time a purchase request is made by the user and determining whether the user has sufficient funds in the user's account to complete the transaction.

34. The method of claim 33, further comprising the steps of authorizing the sale if the user has sufficient funds in the user account for the transaction.

35. The method of claim 33, further comprising the steps of denying the sale if the user has insufficient funds in the user account for the transaction and permitting the user to remove items that it requested to purchase until the user has sufficient funds in the user account to complete the transaction.

36. The method of claim 35, further comprising the step of accepting a credit card payment as a substitute for said pre-paid cards.

37. The method of claim 35, further comprising the step of providing a shopping cart on said Internet web site in which the user may store items that the user wishes to purchase until the actual transaction is completed.

38. A networked system for selling goods and services on a networked system comprising: means for maintaining and updating on said networked system a database of PINS previously distributed to point of sale pre-paid card managers, wherein said managers issue said PINS to pre-paid e-cash cards;
means for creating and updating a user account database on said networked system wherein users of said networked system may store a PIN from a previously purchased pre-paid e-cash card, said PIN corresponding to a particular cash value;
means for displaying embedded windows for a plurality of merchants; and
means for accepting as payment said pre-paid cards and corresponding PINS.

39. The networked system of claim 38, wherein said networked system is an Internet web site and said PIN groups comprise both PINS for purchasing goods and services on said Internet web site and PINS for making telephone calls.

40. The networked system of claim 39, wherein said embedded windows comprises the content of each of said participating merchants web sites and said distributor's banner.

41. The networked system of claim 40, further comprises a means for establishing a protocol with said participating merchants for creating said embedded windows.

42. The networked system of claim 42, wherein said protocol further comprises a means said participating merchants the structure of said participating merchant's web site.

43. The networked system of claim 42, said protocol further comprises the XML for downloading an XML page from said participating merchant's web page.

44. The networked system of claim 43, a secure socket layer in said protocol.

45. The networked system of claim 43, further comprising
means for inquiring whether non-participating merchants would like to become participating merchants; and
means for assisting the user in searching for goods or services which it wishes to purchase, comprising the steps of
means for obtaining from the user information relating to the goods and services which they would like to purchase,
means for searching by the distributor its database of Participating Merchants, and
means for providing the user with a list of goods and services which closely match the information obtained from said user.

46. The networked system of claim 39, said means for creating and updating a user account further comprises:
means for storing, in said user account, a PIN registered by a user, the value of said PIN, and the user's delivery address;
means for updating said the user's account each time a purchase is made wherein the purchase price is deducted from the user's account;
means for updating said user's account each time a PIN is added to the user's account; and
means for generating soft codes for unlocking said inactive PIN layers.

47. The networked system of claim 46, wherein said means for accepting as payment said pre-paid cards further comprises a means reviewing the user's account each time a purchase request is made by the user and means for determining whether the user has sufficient funds in the user's account to complete the transaction.

48. The networked system of claim 47, further comprising means for authorizing the sale if the user has sufficient funds in the user account for the transaction.

49. The networked system of claim 47, further comprising means for denying the sale if the user has insufficient funds in the user account for the transaction and permitting the user to remove items that it requested to purchase until the user has sufficient funds in the user account to complete the transaction.

50. The networked system of claim 49, further comprising means for accepting a credit card payment as a substitute for said pre-paid cards.

51. The networked system of claim 49, further comprising means for providing a shopping cart on said Internet web site in which the user may store items that the user wishes to purchase until the actual transaction is completed.
